(19) United States
(12) Patent Application Publication
(10) Pub. No.: US 2026/0051445 A1
(43) Pub. Date: Feb. 19, 2026

(54) EXPLOSION-PROOF SWITCH AND EXPLOSION-PROOF ELECTRICAL DEVICE

(71) Applicant: SHENZHEN BILLDA TECHNOLOGY CO.,LTD, SHENZHEN (CN)

(72) Inventors: JIANJUN KE, SHENZHEN (CN); QIU FENG, SHENZHEN (CN); YUYANG ZHANG, SHENZHEN (CN)

(21) Appl. No.: 18/942,919

(22) Filed: Nov. 11, 2024

(30) Foreign Application Priority Data
Aug. 14, 2024 (CN) 202421973795.X

(51) Int. Cl. H01H 13/06; H01H 13/14

(52) U.S. Cl. CPC H01H 13/06; H01H 13/14

(57) ABSTRACT

The invention provides an explosion-proof switch and an explosion-proof electrical device. A first sealing element is in seal contact with a switch element and an inner wall of a first receiving cavity, a lead cable has an end connected to the switch element and an end penetrating through a cable hole and stretching out of a first protective shell, and a second sealing element is arranged in the cable hole and in seal contact with an inner wall of the cable hole and the lead cable. An assembly clearance between the switch element and the first protective shell and an assembly clearance between the lead cable and the first protective shell are sealed to improve the sealing performance of the explosion-proof switch, thus avoiding a short circuit or an explosion.

### BACKGROUND OF THE INVENTION

### 1. Technical Field

The invention relates to the technical field of explosion-proof electrical devices, in particular to an explosion-proof switch and an explosion-proof electrical device.

### 2. Description of Related Art

In related art, explosion-proof electrical devices (such as lamps and instruments) are controlled to be turned on and off in use by means of a button switch, wherein the button switch, as an independent component, typically comprises a shell, a switch element, a button and a lead cable, two ends of the shell are connected, the switch element and the button are arranged in one end of the shell, and the lead cable is arranged in the other end of the shell. However, due to the presence of an assembly clearance between the switch element and an inner wall of the shell and an assembly clearance between the lead cable and the inner wall of the shell, the sealing performance of the button switch is poor, rainwater and other flammable and explosive fluids in the external environment easily enter the explosion-proof electrical devices by means of the button switch, leading to a short circuit or an explosion.

### BRIEF SUMMARY OF THE INVENTION

The technical issue to be settled by the invention is to provide an explosion-proof switch and an explosion-proof electrical device to solve the problem of poor sealing performance of button switches in the related art.

To settle the above technical issue, in a first aspect, the invention provides an explosion-proof switch, comprising:
a first protective shell, provided with a first receiving cavity and a cable hole connected to the first receiving cavity;
a switch element, arranged in the first protective shell and received in the first receiving cavity;
a first sealing element, disposed around an outer side of the switch element and in seal contact with the switch element and an inner wall of the first receiving cavity;
a lead cable, having an end connected to the switch element and an end penetrating through the cable hole and stretching out of the first protective shell; and
a second sealing element, arranged in the cable hole and in seal contact with an inner wall of the cable hole and the lead cable.

Optionally, the second sealing element is filled in the cable hole.

Optionally, a diameter of the cable hole is 10 mm-15 mm, and a length of the cable hole is 20 mm-25 mm.

Optionally, a circular mounting groove is formed in the inner wall of the cable hole, and the second sealing element is arranged in the mounting groove.

Optionally, a first stop protrusion is arranged on the outer side of the switch element and abuts against an end of the first protective shell, and the first sealing element is arranged on a side, close to the lead cable, of the first stop protrusion.

Optionally, the first protective shell comprises:
a main portion, provided with the first receiving cavity; and
a connecting portion, provided with the cable hole, wherein a first mounting structure and a third mounting structure are arranged on an outer side of the connecting portion, the first mounting structure is used for fixing the connecting portion to a device body of an explosion-proof electrical device, and the third sealing element is in contact with the connecting portion and the device body of the explosion-proof electrical device.

Optionally, the explosion-proof switch further comprises a first flame-retardant element, the first flame-retardant element is disposed around the outer side of the connecting portion, the third sealing element is arranged between the first flame-retardant element and the connecting portion, and the first flame-retardant element is in contact with the device body of the explosion-proof electrical device.

Optionally, the explosion-proof switch further comprises:
a second protective shell, arranged at an end, away from the lead cable, of the first protective shell and located on an outer side of the first protective shell, wherein a second receiving cavity is formed in the second protective shell, a second mounting structure is arranged on the outer side of the second protective shell, and the second mounting structure is used for fixing the second protective shell to a device body of an explosion-proof device; and
a button, slidably assembled on the second protective shell and received in the second receiving cavity, wherein the button is able to slide to be in contact with or separated from the switch element to turn on or off the switch element.

Optionally, the explosion-proof switch further comprises a second flame-retardant element, and the second flame-retardant element is disposed around the outer side of the second protective shell and is in contact with the device body of the explosion-proof device.

In a second aspect, the invention provides an explosion-proof electrical device, comprising the explosion-proof switch and a device body, wherein the explosion-proof switch is arranged on device body and electrically connected to the device body.

Compared with the prior art, the explosion-proof switch and the explosion-proof electrical device provided by the invention have the following beneficial effects: the first sealing element is in seal contact with the switch element and the inner wall of the first receiving cavity to seal an assembly clearance between the switch element and the first protective shell, and the second sealing element is in seal contact with the inner wall of the cable hole and the lead cable to seal an assembly clearance between the lead cable and the first protective shell, such that the sealing performance of the explosion-proof switch is improved, and rainwater and other flammable and explosive fluids in the external environment are prevented from entering the explosion-proof electrical device via the assembly clearances of the explosion-proof switch, thus avoiding a short circuit or an explosion.

### BRIEF DESCRIPTION OF THE SEVERAL VIEWS OF THE DRAWINGS

To more clearly explain the technical solutions in the embodiments of the invention or the related art, drawings used for describing the embodiments of the invention or the related art are briefly introduced below. Obviously, the drawings in the following description merely illustrate some embodiments of the invention, and those skilled in the art can obtain other drawings according to the following ones without creative labor.

FIG. 1 is a schematic structural diagram of an internally locked explosion-proof switch according to the invention;

FIG. 2 is a sectional view of the internally locked explosion-proof switch according to the invention;

FIG. 3 is a schematic structural diagram of an externally locked explosion-proof switch according to the invention;

FIG. 4 is a sectional view of the externally locked explosion-proof switch according to the invention.

Reference signs in the FIGS.: 1, first protective shell; 11, main portion; 111, first receiving cavity; 112, first connecting structure; 113, third connecting structure; 12, connecting portion; 121, cable hole; 2, switch element; 21, first stop protrusion; 22, pin; 23, second connecting structure; 3, second protective shell; 31, second receiving cavity; 32, second stop protrusion; 33, receding hole; 34, third stop protrusion; 35, fourth connecting structure; 4, button; 41, fourth stop protrusion; 5, first sealing element; 6, lead cable; 7, second sealing element; 8, third sealing element; 9, first mounting structure; 10, first flame-retardant element; 20, second mounting structure; 30, second flame-retardant element; 40, gasket.

### DETAILED DESCRIPTION OF THE INVENTION

The embodiments of the invention are described in detail below, and examples of the embodiments are illustrated in the accompanying drawings, in which identical or similar reference signs indicate identical or similar elements or elements with identical or similar functions. The embodiments described below with reference to the accompanying drawings are merely illustrative ones used for explaining the invention and should not be construed as limitations of the invention. All other embodiments obtained by those ordinarily skilled in the art based on the following ones without creative labor should also fall within the protection scope of the invention.

In the description of the invention, it should be understood that terms such as “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “anticlockwise”, “axial”, “circumferential” and “radial” are used for indicating directional or positional relationships based on the accompanying drawings merely for the purpose of facilitating and simplifying the description of the invention, do not indicate or imply that devices or elements referred to must be in a specific direction or be configured and operated in a specific direction, and thus should not be construed as limitations of the invention.

In addition, terms “first” and “second” are merely for the purpose of description and should not be construed as indicating or implying relative importance or the number of technical features referred to. Therefore, a feature defined by “first” or “second” may explicitly or implicitly indicate the inclusion of one or more said features. In the description of the invention, “multiple” and “a plurality of” means two or more, unless otherwise expressly defined.

### Embodiments

One embodiment of the invention provides an explosion-proof electrical device, comprising an explosion-proof switch and a device body, wherein the explosion-proof switch is arranged on the device body and electrically connected to the device body to control the explosion-proof electrical device to be turned on and off. In some specific examples, the explosion-proof electrical device may be an explosion-proof lamp, an explosion-proof instrument, an explosion-proof motor or the like.

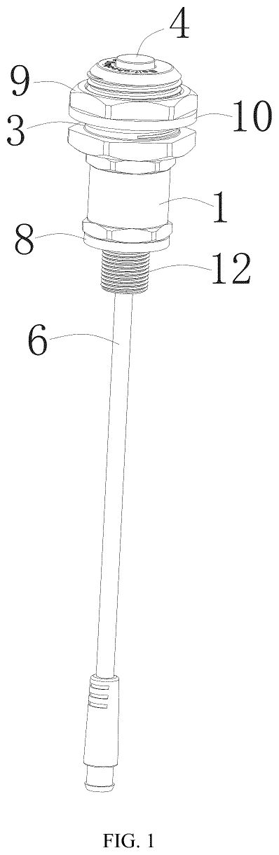

Referring to FIGS. 1-4, the explosion-proof switch comprises a first protective shell 1, a switch element 2, a first sealing element 5, a lead cable 6 and a second sealing element 7. The first protective shell 1 is provided with a first receiving cavity 111 and a cable hole 121, and the cable hole 121 is connected to the first receiving cavity 111; the switch element 2 is arranged in the first protective shell 1 and received in the first receiving cavity 111; the first sealing element 5 is disposed around an outer side of the switch element 2 and is in seal contact with the switch element 2 and an inner wall of the first receiving cavity 111; one end of the lead cable 6 is connected to the switch element 2, and the other end of the lead cable 6 penetrates through the cable hole 121 and stretches out of the first protective shell 1; and the second sealing element 7 is arranged in the cable hole 121 and is in seal contact with an inner wall of the cable hole 121 and the lead cable 6.

The first sealing element 5 is in seal contact with the switch element 2 and the inner wall of the first receiving cavity 111 to seal an assembly clearance between the switch element 2 and the first protective shell 1, and the second sealing element 7 is in seal contact with the inner wall of the cable hole 121 and the lead cable 6 to seal an assembly clearance between the lead cable 6 and the first protective shell 1, such that the sealing performance of the explosion-proof switch is improved, and rainwater and other flammable and explosive fluids in the external environment are prevented from entering the explosion-proof electrical device via the assembly clearances of the explosion-proof switch, thus avoiding a short circuit or an explosion.

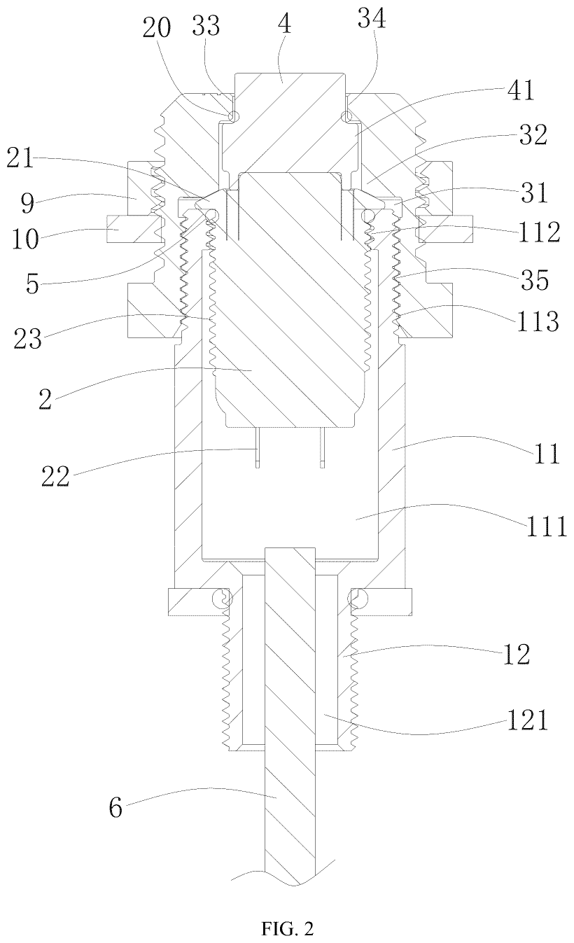

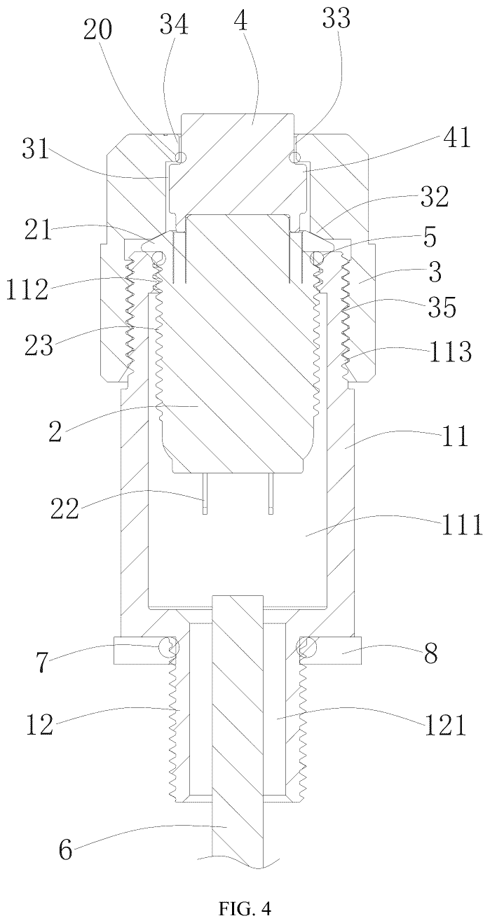

It should be noted that as shown in FIGS. 2 and 4, the switch element 2 is provided with a pin 22, one end of the lead cable 6 is connected to the pin 22, and the other end of the lead cable 6 stretches out of the first protective shell 1 via the cable hole 121 and is electrically connected to the device body, such that the explosion-proof switch and the device body are connected electrically.

In some embodiments, the second sealing element 7 is filled in the cable hole 121. Specifically, after the lead cable 6 penetrates through the cable hole 121, a sealant is filled in the cable hole 121 to form the second sealing element 7, such that the sealing performance between the lead cable 6 and the first protective shell 1 is good. Wherein, the sealant may be a polyurethane sealant, a neoprene sealant, an epoxy resin sealant, or the like; the diameter of the cable hole 121 is 10 mm-15 mm, such as 10 mm, 11 mm, 12 mm, 13 mm, 14 mm or 15 mm; and the length of the cable hole 121 is 20 mm-25 mm, such as 20 mm, 21 mm, 22 mm, 23 mm, 24 mm or 25 mm, thus ensuring that a sufficient amount of the sealant can be received in the cable hole 121.

In some other embodiments, a circular mounting groove is formed in the inner wall of the cable hole 121, and the second sealing element 7 is arranged in the mounting groove. Specifically, the second sealing element 7 is mounted in the mounting groove first, and then the lead cable 6 penetrates through the second sealing element 7, such that the second sealing element 7 can be easily assembled. Wherein, the second sealing element 7 may be a sealing ring, multiple mounting grooves and multiple sealing rings may be arranged in the cable hole 121, the multiple mounting grooves are distributed at intervals in a length direction of the cable hole 121, and the multiple sealing rings are mounted in the multiple mounting grooves in one-to-one correspondence.

Referring to FIGS. 2 and 4, a first stop protrusion 21 is arranged on the outer side of the switch element 2 and abuts against an end of the first protective shell 1 to prevent the switch element 2 from further moving downwards in the process of assembling the switch element 2 on the first protective shell 1, and the first stop protrusion 21 is able to preliminarily seal the first receiving cavity 111; and the first sealing element 5 is arranged on a side, close to the lead cable 6, of the first stop protrusion 21, such that the first sealing element 5 can seal an assembly clearance between the first stop protrusion 21 and the first protective shell 1 to guarantee the sealing performance. Wherein, the first sealing element 5 may be a sealing ring.

Referring to FIGS. 2 and 4, the first protective shell 1 comprises a main portion 11 and a connecting portion 12. The main portion 11 is provided with the first receiving cavity 111, the connecting portion 12 is provided with the cable hole 121, and the diameter of the cable hole 121 is less than that of the first receiving cavity 111, such that a step structure is formed between the main portion 11 and the connecting portion 12 to facilitate the connection between the connecting portion 12 and the device body of the explosion-proof electrical device. A first mounting structure 9 and a third sealing element 8 are arranged on an outer side of the connecting portion 12, and the first mounting structure 9 is used for fixing the connecting portion 12 to the device body of the explosion-proof electrical device so as to mount the explosion-proof switch on the device body of the explosion-proof electrical device. The third sealing element 8 is disposed around the outer side of the connecting portion 12 and is in seal contact with the connecting portion 12 and the device body of the explosion-proof electrical device, thus guaranteeing the sealing performance between the explosion-proof switch and the device body of the explosion-proof electrical device.

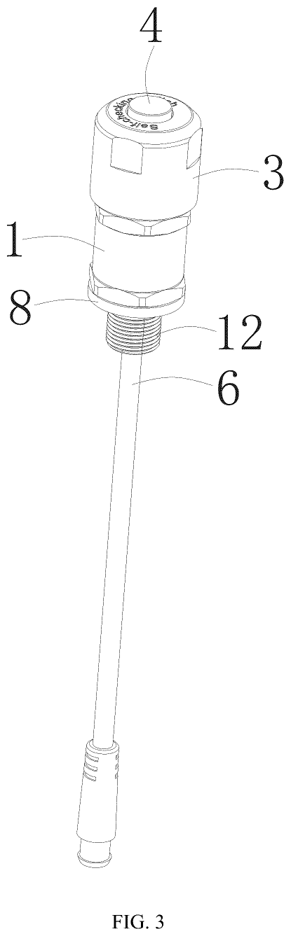

Referring to FIGS. 3 and 4, in some embodiments, threads are arranged on the outer side of the connecting portion 12, the first mounting structure 9 may be a locking nut, and the locking nut is screwed on the outer side of the connecting portion 12, abuts against the device body, and locks and fixes the device body to the step structure between the main portion 11 and the connecting portion 12.

It should be noted that by locking and fixing the connecting portion 12 of the first protection shell 1 to the device body of the explosion-proof electrical device, the whole explosion-proof switch protrudes with respect to an outer surface of the device body and thus can be locked externally.

Referring to FIGS. 3 and 4, the explosion-proof switch further comprises a first flame-retardant element 10, the first flame-retardant element 10 is disposed around the outer side of the connecting portion 12, the third sealing element 8 is arranged between the first flame-retardant element 10 and the connecting portion 12, and the first flame-retardant element 10 is in contact with the device body of the explosion-proof electrical device to prevent combustion caused by a flame between the explosion-proof switch and the device body. Wherein, the first flame-retardant element 10 may be made from flame-retardant silicone rubber.

In some other embodiments, the connecting portion 12 may be clamped or buckled on the device body or connected to the device body in other ways. For example, when the connecting portion 12 is clamped on the device body, the first mounting structure 9 may be a clamping portion arranged on the outer side of the connecting portion 12, a clamping hole is formed in the device body, and the clamping portion is clamped in the clamping hole to mount the explosion-proof switch on the device body of the explosion-proof electrical device.

Referring to FIGS. 2 and 4, the explosion-proof switch further comprises a second protective shell 3 and a button 4. The second protective shell 3 is arranged at an end, away from the lead cable 6, of the first protective shell 1 and located outside the first protective shell 1, a second receiving cavity 31 is formed in the second protective shell 3, the switch element 2 is received in the second receiving cavity 31, and a second mounting structure 20 is arranged on an outer side of the second protective shell 3 and used for fixing the second protective shell 3 to the device body of the explosion-proof electrical device so as to mount the explosion-proof switch on the device body of the explosion-proof electrical device. The button 4 is slidably assembled in the second protective shell 3 and received in the second receiving cavity 31, and the button 4 is able to slide to be in contact with or separated from the switch element 2 to turn on or off the switch element 2, such that the explosion-proof switch can control the explosion-proof electrical device to be turned on and off by means of the button 4.

It should be noted that the switch element 2 is arranged in the first protective shell 1 and the second protective shell 3 and the button 4 is arranged in the second protective shell 3, such that the switch element 2 and the button 4 can be wrapped and protected by the protective shells to suffer from small impacts when the explosion-proof switch is impacted by energy, and the explosion-proof switch can resist impacts and explosions and does not need to be subjected to explosion-proof treatment when mounted on the device body of the explosion-proof electrical device; and when the explosion-proof switch is operated, users just need to press the button 4 and do not need to perform other operations, such that the explosion-proof switch and the explosion-proof electrical device can be used together more easily.

It should be understood that when the button 4 slides to be separated from the switch element 2, an end, away from the switch element 2, of the button 4 stretches out of an end surface of the second protective shell 3, such that users can press the button 4 easily. When the button 4 slides to be in contact with the switch element 2, the end, away from the switch element 2, of the button 4 is flush with the end surface of the second protective shell 3. Wherein, when the explosion-proof switch is impacted by energy, the button 4 will move to be flush with the end surface of the second protective shell 3 under pressure, and at this moment, only one end of the button 4 is exposed, thus further reducing impacts suffered by the button 4.

Referring to FIGS. 1 and 2, in some embodiments, a step structure is arranged on the outer side of the second protective shell 3, threads are arranged on the outer side of the second protective shell 3, the second mounting structure 20 may be a locking nut, and the locking nut is screwed on the outer side of the second protective shell 3, abuts against the device body, and locks and fixes the device body to the step structure of the second protective shell 3.

It should be noted that by locking and fixing the second protective shell 3 to the device body of the explosion-proof electrical device, the whole explosion-proof switch is received in the device body and thus can be locked internally.

Referring to FIGS. 1 and 2, the explosion-proof switch further comprises a second flame-retardant element 30, and the second flame-retardant element 30 is disposed around the outer side of the second protective shell 3 and is in contact with the device body of the explosion-proof electrical device to prevent combustion caused by a flame between the explosion-proof switch and the device body. Wherein, the second flame-retardant element 30 may be made from flame-retardant rubber.

In some other embodiments, the second protective shell 3 may be clamped or buckled on the device body or connected to the device body in other ways. For example, when the second protective shell 3 is clamped on the device body, the second mounting structure 20 may be a clamping portion arranged on the outer side of the second protective shell 3, a clamping hole is formed in the device body, and the clamping portion is clamped in the clamping hole to mount the explosion-proof switch on the device body of the explosion-proof electrical device.

Referring to FIGS. 2 and 4, in some embodiments, the first protective shell 1 and the second protective shell 3 are both cylindrical, and the length of the first receiving cavity 111 and the length of the second receiving cavity 31 extend in an axial direction; and the switch element 2 and the button 4 are both columnar, the length of the switch element 2 extends in a length direction of the first receiving cavity 111, and the button 4 slides in a length direction of the second receiving cavity 31. The first protective shell 1 and the second protective shell 3 are both metal parts, for example, the first protective shell 1 and the second protective shell 3 may be made from stainless steel, nickel-plated copper or other materials.

Referring to FIGS. 2 and 4, a first connecting structure 112 is arranged on an inner wall of the first receiving cavity 111, a second connecting structure 23 is arranged on the switch element 2, and the first connecting structure 112 and the second connecting structure 23 are connected to fix the switch element 2 in the first protective shell 1. In one specific example, the first connecting structure 112 and the second connecting structure 23 are threadedly connected, such that the switch element 2 can be easily fixed to the first protective shell 1; wherein, the first connecting structure 112 may be threads arranged on the inner wall of the first receiving cavity 111, and the second connecting structure 23 may be threads arranged on the outer side of the switch element 2.

It should be noted that the number of the threads on the outer side of the switch element 2 may be greater than the number of the threads on the inner wall of the first receiving cavity 111, such that the machining difficulty of the first protective shell 1 can be lowered; the first stop protrusion 21 is circular and is disposed around an end of the outer side of the switch element 2, and the outer diameter of the first stop protrusion 21 is greater than the diameter of the first receiving cavity 111 to ensure that the first stop protrusion 21 can be in contact with the end of the first protective shell 1. It can be understood that in the process of screwing and threadedly connecting the switch element 2 to the first protective shell 1, when the first stop protrusion 21 abuts against the end of the first protective shell 1, the switch element 2 is screwed in position on the first protective shell 1.

In some other embodiments, the first connecting structure 112 may be inserted into or clamped or buckled on the second connecting structure 213. For example, when the first connecting structure 112 is inserted into the second connecting structure 23, the first connecting structure 112 may be an insertion pillar arranged on the inner wall of the first receiving cavity 111, the second connecting structure 23 may be an insertion hole formed in the switch element 2, and the insertion pillar is inserted into the insertion hole and is in interference fit with the insertion hole to fix the switch element 2 to the first protective shell 1.

Referring to FIGS. 2 and 4, the first protective shell 1 is provided with a third connecting structure 113, an inner wall of the second receiving cavity 31 is provided with a fourth connecting structure 35, and the third connecting structure 113 and the fourth connecting structure 35 are connected to fix the second protective shell 3 to the first protective shell 1. In one specific example, the third connecting structure 113 and the fourth connecting structure 35 are connected threadedly, such that the second protective shell 3 and the first protective shell 1 can be fixed together easily; wherein, the third connecting structure 113 may be threads arranged on the outer side of the first protective shell, and the fourth connecting structure 35 may be threads arranged on the inner wall of the second receiving cavity 31.

Referring to FIGS. 2 and 4, a second stop protrusion 32 is arranged on the inner wall of the second receiving cavity 31 and abuts against an end, away from the first protective shell 1, of the switch element 2 to prevent the second protective shell 3 from further moving downwards in the process of assembling the second protective shell 3 on the first protective shell 1. Wherein, the second stop protrusion 32 is spaced apart from the threads on the second receiving cavity 31, the first stop protrusion 21 is arranged between the first protective shell 1 and the second stop protrusion 32, and the second stop protrusion 32 abuts against a side, away from the first protective shell 1, of the first stop protrusion 21 to prevent the switch element 2 from moving upwards; in addition, a conical surface is arranged on a side, close to the first protective shell 1, of the second stop protrusion, and a conical surface is arranged on a side, away from the first protective shell 1, of the first stop protrusion 21, such that the first stop protrusion 21 and the second stop protrusion 32 can come in contact with each other easily. It can be understood that in the process of screwing and threadedly connecting the first protective shell 1 and the second protective shell 3, when the second stop protrusion 32 abuts against the first stop protrusion 21, the switch element 2 is screwed in position on the first protective shell 1.

It can be understood that the second protective shell 3 may be a locking nut corresponding to the switch element 2, and the second stop protrusion 32 abuts against the first stop protrusion 21, such that the switch element 2 can be locked and fixed to the first protective shell 1 by means of the second protective shell 3.

It should be noted that in some other embodiments, the third connecting structure 113 may be inserted into or clamped or buckled on the fourth connecting structure 35. For example, when the third connecting structure 113 is clamped on the fourth connecting structure 35, the third connecting structure 113 may be a clamping groove formed in the outer side of the first protective shell 1, the fourth connecting structure 35 may be a clamping portion arranged on the inner wall of the second receiving cavity 31, and the clamping protrusion is clamped in the clamping groove to fixed the first protective shell 1 and the second protective shell 3 together.

Referring to FIG. 2 and FIG. 4, the second receiving cavity 31 penetrates through an end surface of the second protective shell 3 from a receding hole 33, and the button 4 penetrates through the receding hole 33 to ensure that the switch element 2 can be exposed out of the surface of the second protective shell 3 via the receding hole 33, such that the button 4 can be pressed easily; the button 4 is light-transmitting and can transmit light in different colors to the outside to display the state of the explosion-proof electrical device, for example, when the button 4 transmits red light to the outside, it indicates that the explosion-proof electrical device is in a fault state; and when the button 4 transmits green light to the outside, it indicates that the explosion-proof electrical device is in a normal operation state; wherein, the button 4 may be made from a transparent acrylic material.

Referring to FIGS. 2 and 4, an inner wall of the receding hole 33 protrudes in the radial direction to form a third stop protrusion 34, a fourth stop protrusion 41 is arranged on an outer side of the button 4, and the fourth stop protrusion 41 is received in the second receiving cavity 31, and the fourth stop protrusion 41 is slidably assembled in the second protective shell 3; wherein, when the button 4 slides to be in contact or separated from the switch element 2, the fourth stop protrusion 41 is spaced apart from the third stop protrusion 34 or abuts against the third stop protrusion 34 to prevent the button 4 from being separated from the second protective shell 3.

As actually needed, the third stop protrusion 34 surrounds the receding hole 33, the fourth stop protrusion 41 may be circular and disposed around the outer side of the button 4, and a gasket 40 is also disposed around the outer side of the button 4 and arranged between the third stop protrusion 34 and the fourth stop protrusion 41, such that collisions between the third stop protrusion 34 and the fourth stop protrusion 41 can be reduced by the gasket 40.

The above embodiments are merely preferred ones of the invention and are not used for limiting the invention, and any amendments, equivalent substitutions and improvements made based on the spirit and principle of the invention should also fall within the protection scope of the invention.

What is claimed is:

1. An explosion-proof switch, comprising:
a first protective shell, provided with a first receiving cavity and a cable hole connected to the first receiving cavity;
a switch element, arranged in the first protective shell and received in the first receiving cavity;
a first sealing element, disposed around an outer side of the switch element and in seal contact with the switch element and an inner wall of the first receiving cavity;
a lead cable, having an end connected to the switch element and an end penetrating through the cable hole and stretching out of the first protective shell; and
a second sealing element, arranged in the cable hole and in seal contact with an inner wall of the cable hole and the lead cable.

2. The explosion-proof switch according to claim 1, wherein the second sealing element is filled in the cable hole.

3. The explosion-proof switch according to claim 2, wherein a diameter of the cable hole is 10 mm-15 mm, and a length of the cable hole is 20 mm-25 mm.

4. The explosion-proof switch according to claim 1, wherein a circular mounting groove is formed in the inner wall of the cable hole, and the second sealing element is arranged in the mounting groove.

5. The explosion-proof switch according to claim 1, wherein a first stop protrusion is arranged on the outer side of the switch element and abuts against an end of the first protective shell, and the first sealing element is arranged on a side, close to the lead cable, of the first stop protrusion.

6. The explosion-proof switch according to claim 1, wherein the first protective shell comprises:
a main portion, provided with the first receiving cavity; and
a connecting portion, provided with the cable hole, wherein a first mounting structure and a third mounting structure are arranged on an outer side of the connecting portion, the first mounting structure is used for fixing the connecting portion to a device body of an explosion-proof electrical device, and the third sealing element is in contact with the connecting portion and the device body of the explosion-proof electrical device.

7. The explosion-proof switch according to claim 6, wherein the explosion-proof switch further comprises a first flame-retardant element, the first flame-retardant element is disposed around the outer side of the connecting portion, the third sealing element is arranged between the first flame-retardant element and the connecting portion, and the first flame-retardant element is in contact with the device body of the explosion-proof electrical device.

8. The explosion-proof switch according to claim 1, wherein the explosion-proof switch further comprises:
a second protective shell, arranged at an end, away from the lead cable, of the first protective shell and located on an outer side of the first protective shell, wherein a second receiving cavity is formed in the second protective shell, a second mounting structure is arranged on the outer side of the second protective shell, and the second mounting structure is used for fixing the second protective shell to a device body of an explosion-proof device; and
a button, slidably assembled on the second protective shell and received in the second receiving cavity, wherein the button is able to slide to be in contact with or separated from the switch element to turn on or off the switch element.

9. The explosion-proof switch according to claim 8, wherein the explosion-proof switch further comprises a second flame-retardant element, and the second flame-retardant element is disposed around the outer side of the second protective shell and is in contact with the device body of the explosion-proof device.

10. An explosion-proof electrical device, comprising the explosion-proof switch according to claim 1 and a device body, wherein the explosion-proof switch is arranged on device body and electrically connected to the device body.
